(19) United States
(12) Patent Application Publication
(10) Pub. No.: US 2013/0272867 A1
(43) Pub. Date: Oct. 17, 2013

(54) MOUNTING DEVICE FOR FAN

(71) Applicant: ZHENG-HENG SUN, Tu-Cheng (TW)

(72) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/473,631

(22) Filed: May 17, 2012

(30) Foreign Application Priority Data
Apr. 12, 2012 (CN) 201210106295.1

(51) Int. Cl. F04D 29/64; F16M 13/02

(52) U.S. Cl. 415/213.1; 248/615

(57) ABSTRACT

A mounting device for fixing a fan having a main body and two opposite boards includes a base board, two blocks to be mounted to opposite sides of the main body and two springs. The base board forms two rods. Each block defines a fixing hole in which a corresponding one of the rods is engaged, and a receiving space surrounding the fixing hole. Each spring has an upper portion received in the receiving space of a corresponding one of the block, and a lower portion extending out of the corresponding receiving room to fit about the corresponding rod.

### CROSS-REFERENCE TO RELATED APPLICATION

Relevant subject matter is disclosed in the pending U.S. patent application, titled “MOUNTING DEVICE FOR FAN”, filed on Apr. 19, 2012, with the application Ser. No. 13/450,505, which is assigned to the same assignee as this patent application.

### BACKGROUND

1. Technical Field

The present disclosure relates to a device for mounting fans.

2. Description of Related Art

Many electronic devices use fans to cool internal components. The fans may be mounted to a rack by a plurality of screws, and then is mounted in an electronic device together with the rack, which adds the additional cost of the rack.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of a mounting device, together with a plurality of fans, wherein the mounting device includes two blocks.

FIG. 2 is inverted view showing the blocks mounted to one of the fans.

FIG. 3 is an assembled, isometric view of the mounting device and the fans of FIG. 1.

FIG. 4 is a cross-sectional view of FIG. 3, taken along the line of IV-IV.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

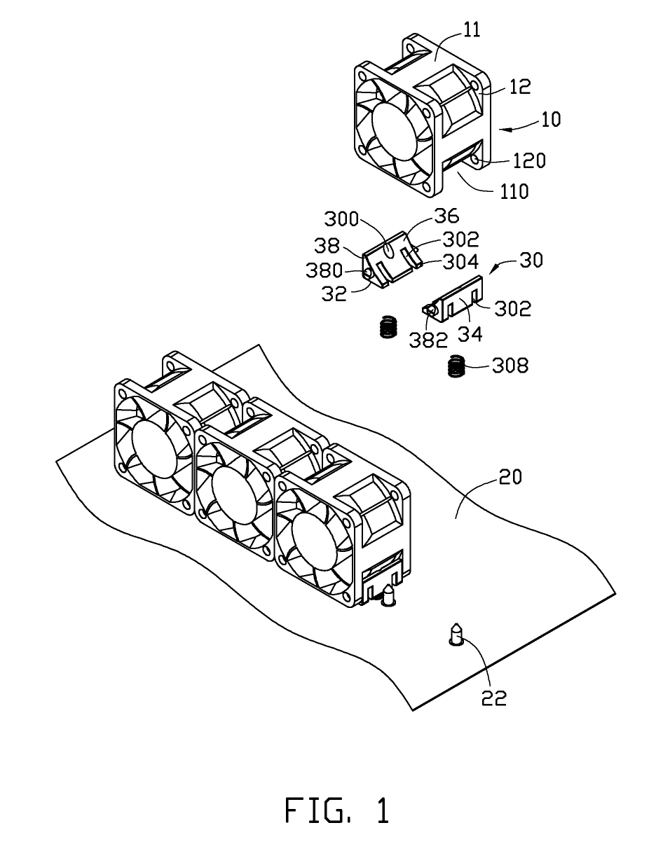

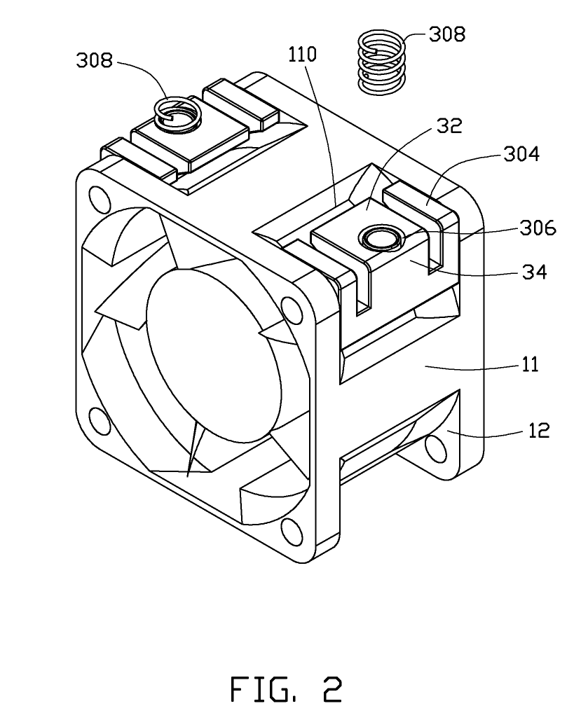

FIGS. 1 and 2 show an exemplary embodiment of a mounting device for fixing a plurality of fans 10. The mounting device includes a base board 20, a plurality of elastic members such as springs 308, and a plurality of blocks 30.

Each fan 10 includes a hollow and substantially rectangular main body 11 and two spaced boards 12 connected to opposite ends of the main body 11. The main body 11 defines a depressed portion 110 in each of two lower sides. Each depressed portion 110 has a curved bottom wall. Each board 12 defines two corner holes 120 in a lower portion of the board 12.

The base board 20 forms a plurality of rods 22. Each rod 22 has a tapered distal end.

Each block 30 has a substantially triangular cross-section. Each block 30 includes a bottom wall 32, a sidewall 34 extending up from a first side of the bottom wall 32 in a substantially perpendicular manner, two end walls 38 extending up from opposite ends of the bottom wall 32 in a substantially perpendicular manner, a concave surface 36 connected between a top side of the sidewall 34 and a second side of the bottom wall 32 opposite to the first side. The concave surface 36 is also connected between the end walls 38. A protrusion 380 extends out from each of the end walls 38. A guiding surface 382 slantingly extends from a top of each protrusion 380 toward a distal end of the protrusion 380. A fixing hole 300 is defined in the block 30, and extends through the bottom wall 32 and an upper portion of the concave surface 36. Two slots 302 are defined in the block 30, at opposite sides of the fixing hole 300. Each slot 302 extends through the bottom wall 32, the sidewall 34, and a lower portion of the concave surface 36. Therefore, the block 30 has two deformable cantilevers 304 divided by the slots 302 and formed at opposite ends of the block 30. The bottom wall 32 defines a receiving space 306 surrounding the fixing hole 32. Each spring 308 has an upper portion received in the receiving space 306 of a corresponding one of the blocks 30, and a lower portion extending out from the corresponding receiving space 306.

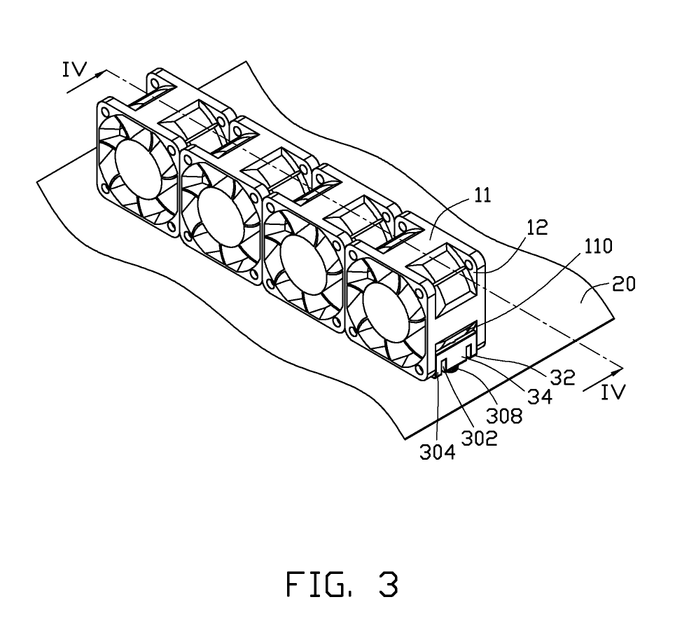

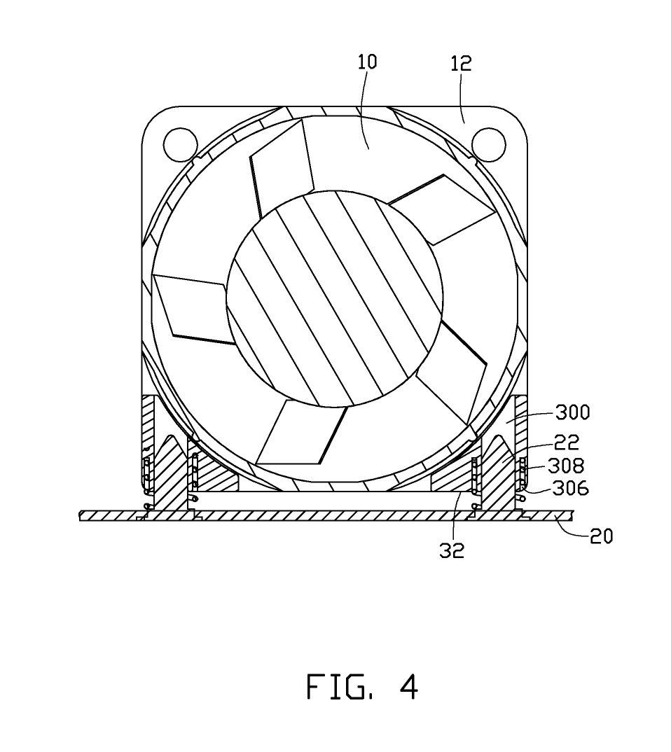

Referring to FIGS. 3 and 4, in mounting each fan 10 to the base board 20, two blocks 30 are aligned with and moved toward the corresponding depressed portions 110 of the fan 10. The guiding surfaces 382 abut against bottoms of the corresponding boards 12 to deform the cantilevers 304 toward each other. The distal end surfaces of the protrusions 380 slidably abut against inner surfaces of the corresponding boards 12, until the protrusions 380 align with the corresponding corner holes 120. The cantilevers 304 are restored to bias the protrusions 380 to engage in the corresponding corner holes 120. Therefore, the blocks 30 are received in the corresponding depressed portions 110, and are sandwiched between the boards 12. The concave surfaces 36 are contacted with the bottom walls of the corresponding depressed portions 112.

The lower portions of the springs 308 and the fixing holes 300 fit about the corresponding rods 22. Bottom ends of the springs 308 abut against the base board 20, so the fan 10 is spaced from and fixed to the base board 20. The springs 308 can absorb vibration generated by the fan 10. In another embodiment, the springs 308 can be replaced by two elastic cushions.

In uninstalling one of the fans 10, the fan 10 is moved away from the base board 20 to disengage the springs 308 and the rods 22 from the corresponding fixing holes 300. The cantilevers 304 of each block 30 are deformed toward each other, to disengage the protrusions 380 from the corresponding corner holes 120. Therefore, the block 30 can be easily removed from the fan 10.

It is believed that the present embodiments and their advantages will be understood from the foregoing description, and various changes may be made thereto without departing from the spirit and scope of the description or sacrificing all of their material advantages, the examples hereinbefore described merely being exemplary embodiments.

What is claimed is:

1. A mounting device for mounting a fan having a main body and two opposite boards connected to opposite ends of the main body, comprising:
two blocks to be mounted to opposite sides of a bottom of the main body of the fan; each block comprising a bottom wall defining a fixing hole and a receiving space surrounding the fixing hole;
a base board forming two rods to be engaged in the fixing holes of the corresponding blocks; and
two elastic members each having an upper portion received in the receiving space of a corresponding one of the blocks, and a lower portion extending out of the receiving space and fitted about a corresponding one of the rods, a bottom end of each elastic member abutting again the base board.

2. The mounting device of claim 1, wherein each block is to be sandwiched between the boards, two protrusions extend out from opposite ends of each block to be engaged in the corresponding boards of the fan.

3. The mounting device of claim 2, wherein a guiding surface slantingly extends down from a top of each protrusion toward a distal end of the protrusion.

4. The mounting device of claim 1, wherein each block has a substantially triangular cross-section, and further comprises a sidewall perpendicularly extending up from a first side of the bottom wall, and a concave surface connected between a top side of the sidewall and a second side of the bottom wall opposite to the first side, each concave surface contacts the main body of the fan, the fixing hole of each block extends through the bottom wall and the concave surface.

5. The mounting device of claim 4, wherein two slots are defined in each block at opposite sides of the fixing hole, each slot extends through the bottom wall, a lower portion of the concave surface, and the sidewall, thereby, the block forming two deformable cantilevers at opposite ends and divided by the slots.

6. The mounting device of claim 1, wherein the elastic members are springs.

7. An assembly, comprising:
a base board forming two rods;
a fan comprising a main body and two boards perpendicularly connected to opposite ends of the main body;
two blocks mounted to opposite sides of a bottom of the main body of the fan, and sandwiched between the boards; each block comprising a bottom wall defining a fixing hole fitting about a corresponding one of the rods and a receiving space surrounding the fixing hole; and
two elastic members each having an upper portion received in the receiving space of a corresponding one of the blocks, and a lower portion extending out of the receiving room and fitted about a corresponding one of the rods, a bottom end of each elastic member abutting again the base board.

8. The assembly of claim 7, wherein two protrusions extend out from opposite ends of each block and are engaged in the corresponding boards of the fan.

9. The assembly of claim 8, wherein a guiding surface slantingly extends down from a top of each protrusion toward a distal end of the protrusion.

10. The assembly of claim 7, wherein each block has a substantially triangular cross-section, and comprises a bottom wall, a sidewall perpendicularly extending up from a first side of the bottom wall, and a concave surface connected between a top side of the sidewall and a second side of the bottom wall opposite to the first side, each concave surface contacts the main body of the fan, the fixing hole of each block extends through the bottom wall and the concave surface.

11. The assembly of claim 10, wherein two slots are defined in each block at opposite sides of the fixing hole, each slot extends through the bottom wall, a lower portion of the concave surface, and the sidewall, thereby, the block forming two deformable cantilevers at opposite ends and divided by the slots.

12. The assembly of claim 7, wherein the elastic members are springs.
